(19) United States
(12) Patent Application Publication
(10) Pub. No.: US 2026/0195322 A1
(43) Pub. Date: Jul. 9, 2026

(54) INTEGRATED LLM IN DATABASE SEARCH

(71) Applicant: SAP SE, Walldorf (DE)

(72) Inventors: Alef Farah, Santa Cruz do Sul - RS (BR); Gabriel Tamujo Meyrer, São Leopoldo - RS (BR); Stefan Da Matta Zanona, Porto Alegre - RS (BR); Daniel Cristiano Menzen, Porto Alegre - RS (BR); Marcos Vinicius Fofonka, Porto Alegre - RS (BR); Gabriel Castrol Silva, Porto Alegre - RS (BR)

(21) Appl. No.: 19/013,721

(22) Filed: Jan. 8, 2025

(51) Int. Cl. G06F 16/242; G06F 16/248; G06F 40/284

(52) U.S. Cl. CPC G06F 16/243; G06F 16/248; G06F 40/284

(57) ABSTRACT

This disclosure describes systems, software, and computer implemented methods for initiating a large language model (LLM) with a base prompt, the base prompt providing the LLM with a set of possible output actions, and constraining the LLM to respond with a thought response, output action, or an answer response; receiving, a natural language query; providing the natural language query to the LLM; receiving a first response from the LLM comprising a first token and a structured query; passing the structured query including the arguments to a database on behalf of the user; receiving a return from the database; generating a return token and providing the return token and the return from the database to the LLM; receiving a second response from the LLM, the second response comprising a second token indicating that the second response is an answer response; and providing the second response to the user.

### BACKGROUND

Some data repositories require queries of a specific structure for processing. Large language models (LLMs) can ingest and respond to natural language, but generally provide unstructured responses. To effectively query certain data repositories, the LLM must be able to provide structured queries to those data repositories.

### SUMMARY

The present disclosure involves systems, software, and computer implemented methods for using an AI model to integrate with structured data repositories. Solutions can include initiating a large language model (LLM) with a base prompt, the base prompt providing the LLM with a set of possible output actions, and constraining the LLM to respond with a thought response, output action, or an answer response; receiving, from a user, a natural language query; providing the natural language query to the LLM; receiving a first response from the LLM comprising a first token and a structured query, wherein the first token indicates that the first response is an output action, and wherein the structured query includes one or more arguments; passing the structured query including the arguments to a database on behalf of the user; receiving a return from the database; generating a return token and providing the return token and the return from the database to the LLM, the return token indicating that the return from the database is in response to the structured query; receiving a second response from the LLM, the second response comprising a second token indicating that the second response is an answer response; and providing the second response to the user.

Implementations can optionally include one or more of the following features.

In some instances, the structured query is a travel search query requesting a travel booking, and wherein the arguments include travel dates and locations, and wherein the arguments are determined by the LLM based on the natural language query.

In some instances, determining the arguments by the LLM based on the natural language query includes: receiving an answer response from the LLM requesting additional information from the user; sending the answer response requesting additional information to the user; receiving a user response comprising the additional information; and sending the user response to the LLM.

In some instances, receiving the natural language query from the user includes receiving a set of credentials from the user, wherein passing the structured query to the database on behalf of the user includes passing the set of credentials to the database.

In some instances, passing the structured query to the database on behalf of the user includes passing user policy information to the database, and wherein the return from the database is based on the user policy information.

In some instances, the structured query is a query for flight information, and wherein passing the structured query to the database includes passing the structured query to a database coordinator to search a plurality of database sources and retrieve flight information.

In some instances, passing the structured query to the database includes: extracting structured arguments from the arguments using a language parsing library.

In some instances, the database is a first database, and wherein passing the structured query including the arguments to the database includes: passing the structured query to the first database and receiving a first result; refining the structured query with the first result; passing the refined structured query to a second database and receiving a second result; and providing the second result as the return from the database.

In some instances, refining the structured query with the first result includes inserting UUIDs from the first result into the structured query.

The details of these and other aspects and embodiments of the present disclosure are set forth in the accompanying drawings and the description below. Other features, objects, and advantages of the disclosure will be apparent from the description, drawings, and claims.

### DESCRIPTION OF DRAWINGS

Some example embodiments of the present disclosure are illustrated by way of example and not limitation in the figures of the accompanying drawings, in which like reference numbers indicate similar elements.

FIG. 1 illustrates a schematic diagram of a system for using an AI model to integrate with structured data repositories.

FIG. 2A is a swim lane diagram of an example process 200A for using an AI model to integrate with structured data repositories.

FIG. 2B is a swim lane diagram of an example process 200B for using an AI model to integrate with structured data repositories.

FIG. 3 is a flowchart of an example process 300 for using an AI model to integrate with structured data repositories.

FIGS. 4A-4B are an example UI of an implementation using an AI model for travel booking.

FIG. 5 is a block diagram illustrating an example of a computer-implemented system.

### DETAILED DESCRIPTION

This disclosure describes methods, software, and systems for using an AI model to integrate with structured data repositories. Certain search and data access functionality requires routine queries of real-time information that changes regularly. For example, travel booking can require recent information regarding flight information, pricing, and timing.

One example solution includes a virtual assistant capable of building personalized itineraries based on user preferences and real-time flight information, with an architecture that allows plugging in tools to enhance the assistant's capabilities, such as lodgings search and booking, car rentals APIs, etc.

The user can interface with this example solution in a similar manner to a chat bot, however this chat bot is capable of not only providing textual replies to the user's queries, but also of autonomously querying global data services (GDSs) and search engines for real time information. This is enabled by a prompt that is engineered to steer a large language model (LLM) to produce a chain-of-thought-like output containing actionable steps, in the form of which actions to take from a predefined set (e.g., the tools that can be plugged in) and user input, for example, calling a flights search API with the requested itinerary as input. The actionable step is executed by the underlying implementation, and its output embedded into the original output from the LLM, which is fed back to the LLM until a final goal is reached. In this example, the final goal can be an itinerary having been successfully built for the user.

This solution yields technical advantages because the use of an LLM provides a natural, easy to use interface that enables users to perform functionally complex queries with little or no expertise. Another advantage is by restraining the LLM to a chain-of-thought output, the LLM will provide accurate (e.g., without hallucination) outputs that include updated data from various, disparate, data sources.

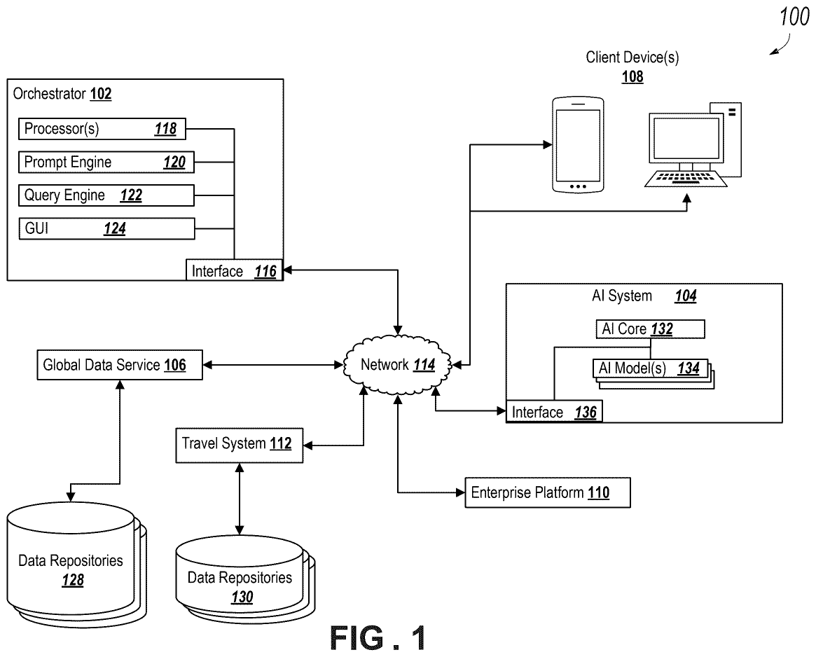

Turning to the illustrated example implementations, FIG. 1 illustrates a schematic diagram of a system 100 for using an AI model to integrate with structured data repositories. The system 100 includes an orchestrator 102, AI system 104, a global data service 106 (which can act as a search service, for example), one or more client devices 108, and an enterprise platform 110, which can communicate using a network 114.

As illustrated, the orchestrator 102 includes a processor 118, prompt engine 120, query engine 122, GUI 124, and an interface 116. In some implementations, the orchestrator 102 operates as a cloud-based service. Further, different portions of the orchestrator 102 can be distributed or otherwise in separate locations, on separate networks, or on separate hardware systems.

Interface 116 is used by the orchestrator 102 to communicate with other systems in a distributed environment—including within the system 100—connected to the network 114 (e.g., client devices 108, and other systems communicably coupled to the illustrated orchestrator 102 and/or network 114. Generally, the interface 116 comprises logic encoded in software and/or hardware in a suitable combination and operable to communicate with the network 114 and other components. More specifically, the interface 116 can comprise software supporting one or more communication protocols associated with communications such that the network 114 and/or interface's 116 hardware is operable to communicate physical signals within and outside of the illustrated system 100. Still further, the interface 116 can allow the orchestrator 102 to communicate with the client 108, and in some implementations, AI system 104, and/or other portions illustrated within the system 100 to perform the operations described herein.

Although illustrated as a single processor 118 in FIG. 1, multiple processors can be used according to particular needs, desires, or particular implementations of the system 100. Each processor 118 can be a central processing unit (CPU), an application specific integrated circuit (ASIC), a field-programmable gate array (FPGA), or another suitable component. Generally, the processor 118 executes instructions and manipulates data to perform the operations of the orchestrator 102. Specifically, the processor 118 executes the algorithms and operations described in the illustrated figures, as well as the various software modules and functionality, including the functionality for sending communications to and receiving transmissions from client devices 108, as well as to other devices and systems. Each processor 118 can have a single or multiple cores, with each core available to host and execute an individual processing thread. Further, the number of, types of, and particular processors 118 used to execute the operations described herein can be dynamically determined based on a number of requests, interactions, and operations associated with the orchestrator 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

The prompt engine 120 can be used by the orchestrator 102 to generate and send prompts to AI system 104 and receive outputs from the AI system 104 and direct them to the appropriate target. In some implementations, the prompt engine 120 receives queries from user devices 108 via the GUI 124, and formats them before passing them to the AI system 104. In some implementations the prompt engine 120 include a repository of predefined prompts and available function calls that enable the AI system 104 to direct prompts to various plug-ins and APIs (e.g., within the search service 106, GUI 124, or other component within system 100).

In some implementations, when the prompt engine 120 receives an output from the AI system 104, the prompt engine 120 analyzes the output, and directs it to the appropriate location. For example, if the output includes an answer token, the prompt engine 120 can direct it to the GUI 124 for consumption by the client devices 108. If instead the output includes a function token, the prompt engine 120 can direct the output to the query engine 122 which processes the function.

Query engine 122 can receive queries from the AI system 104 or the client devices 108 and process them to retrieve information from various remote systems and services. For example, the query engine 122 can pass a structured query to the global data service 106, which can return certain detailed information or applicable data. The query engine can further query specific systems or APIs such as the enterprise platform 110, or travel system 112. For example, the query engine 122 can receive a query for “available flights from Dallas” and send a query to the global data service 106, which returns data indicating two possible airports in Dallas, Dallas Love Field (KDAL) and Dallas Fort Worth International Airport (KDFW). Additionally, the query engine 122 can query the privileges and policies associated with the specific user from the enterprise platform 110, which can have unique rulesets or capabilities based on the particular user or user device 108. The query engine 122 can then provide a structured query to the travel system 112 looking for current flights available from KDAL and KDFW that satisfy the requirements provided by the enterprise platform 110.

GUI 124 of the orchestrator 102 interfaces with at least a portion of the system 100 for any suitable purpose, including generating a visual representation of any particular application or results and/or the content associated with any components of the client devices 108. In particular, the GUI 124 can be used to present results of a query or allow the user to input queries to the orchestrator 102, as well as to otherwise interact and present information associated with one or more applications. GUI 124 can also be used to view and interact with various web pages, applications, and web services located local or external to the orchestrator 102. Generally, the GUI 124 provides the user with an efficient and user-friendly presentation of data provided by or communicated within the system. The GUI 124 can include a plurality of customizable frames or views having interactive fields, pull-down lists, and buttons operated by the user. In general, the GUI 124 is often configurable, supports a combination of tables and graphs (bar, line, pie, status dials, etc.), and is able to build real time portals, application windows, and presentations. Therefore, the GUI 124 contemplates any suitable graphical user interface, such as a combination of a generic web browser, a web-enable application, intelligent engine, and command line interface (CLI) that processes information in the platform and efficiently presents the results to the user visually.

Client devices 108 are computing devices or computers used by one or more users to interact with the orchestrator 102. In some cases, system 100 describes an enterprise computing environment, where the user consumes database objects (e.g., DATA 126A-N). As used in the present disclosure, the term “computer” or “computing devices” is intended to encompass any suitable processing device. For example, the client devices 108 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. Similarly, the client devices 108 can be any system that can request data and/or interact with the orchestrator 102. The client device(s) 108, in some instances, can be a desktop system, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The client devices 108 can include one or more specific applications executing on the client devices 108, or the client devices 108 can include one or more Web browsers or web applications that can interact with particular applications executing remotely from the client devices 108.

Network 114 facilitates wireless or wireline communications between the components of the system 100 (e.g., between the orchestrator 102, the client devices 108, etc.), as well as with any other local or remote computers, such as additional mobile devices, clients, servers, or other devices communicably coupled to network 114, including those not illustrated in FIG. 1. In the illustrated environment, the network 114 is depicted as a single network, but can comprise more than one network without departing from the scope of this disclosure, so long as at least a portion of the network 114 can facilitate communications between senders and recipients. In some instances, one or more of the illustrated components (e.g., the search service 106, the AI system 104, etc.) can be included within or deployed to network 114 or a portion thereof as one or more cloud-based services or operations. The network 114 can be all or a portion of an enterprise or secured network, while in another instance, at least a portion of the network 114 can represent a connection to the Internet. In some instances, a portion of the network 114 can be a virtual private network (VPN). Further, all or a portion of the network 114 can comprise either a wireline or wireless link. Example wireless links can include 802.11a/b/g/n/ac, 802.20, WiMax, LTE, and/or any other appropriate wireless link. In other words, the network 114 encompasses any internal or external network, networks, sub-network, or combination thereof operable to facilitate communications between various computing components inside and outside the illustrated system 100. The network 114 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

The AI system 104 enables other engines and applications to interact with one or more AI models 134 in a secure manner. That is, the AI system 104 generally provides access to large-scale third-party models, while ensuring that data used in prompting those models, or training new models remains in the custody of the orchestrator 102. The AI system 104 can include an interface 136, which can be similar to or different from interface 116 as described above. The AI system 104 can further include an AI core 132 which manages prompts and training commands amongst an array of hosted AI models 134.

The AI core 132 can constrain the AI models 134 by grounding their outputs to ensure they do not provide or reduce the frequency of hallucinations. This can be accomplished, for example, with prompt engineering, in-context learning, and retrieval-augmented generation (RAG).

The AI models 134 can be foundation models that are used to generate a response to a given prompt. In some implementations, the AI models 134 are large AI neural networks trained on large sets of unlabeled data, often through self-supervised learning. These models, once trained, can perform specific tasks such as image classification, natural language processing, question answering, or embedding. Embedding, for example, is generating a numerical representation of data in a lower-dimensional space to convert complex information such as text, images, or audio, into a format that is more efficiently processed by computers. Example AI models 134 can include, but are not limited to, large language models (LLMs), Bidirectional encoder representations from Transformers (BERT), or other transformer-based networks.

The AI models 134 can be provided by a third party or external source, such as OpenAI, or Google, which can provide a base model with some foundational training. In some implementations, the AI core 132 enables users of the orchestrator 102 to provide their own AI models 134. In some implementations, a model of the AI model(s) 134 can be further trained or fine-tuned to provide an optimized model version adjusted to the orchestrator 102 when providing services to end users to generate structured queries. The further training or fine-tuning can be performed for a particular context or given field, such as software development projects and/or particular organization. Additionally, the further training or fine-tuning can be performed on a specific training data set and/or restrained based on custom criteria.

Global data services 106 and travel system 112 can be services that respond to structured queries by searching their associated repositories 128 and 130 and returning a result. In some implementations, these services 106 and 112 are maintained and operated by the enterprise platform 110, which can be an enterprise software system that, in some instances, also manages and maintains the orchestrator 102 and/or other components within and external to system 100.

Data repositories 128 and 130 can represent a single memory or multiple memories. The repositories 128 and 130 can include any memory or database module and can take the form of volatile or non-volatile memory including, without limitation, magnetic media, optical media, random access memory (RAM), read-only memory (ROM), removable media, or any other suitable local or remote memory component. The repositories 128 and 130 can store various objects or data, including digital asset data, public keys, user and/or account information, administrative settings, password information, caches, applications, backup data, repositories storing business and/or dynamic information, and any other appropriate information associated with the global data service 106 and travel system 112, including any parameters, variables, algorithms, instructions, rules, constraints, or references thereto. Additionally, the repositories 128 and 130 can store any other appropriate data, such as VPN applications, firmware logs and policies, firewall policies, a security or access log, print or other reporting files, as well as others. While illustrated within the system 100, repositories 128 and 130 or any portion thereof, including some or all of the particular illustrated components, can be located remote from the system 100 in some instances, including as a cloud application or repository or as a separate cloud application or repository when the system 100 itself is a cloud-based system. In some instances, some or all of data repositories 128 and 130 can be located in, associated with, or available through one or more other systems of the associated enterprise software platform 110. In those examples, the data stored in memory can be accessible, for example, via one of the described applications or systems.

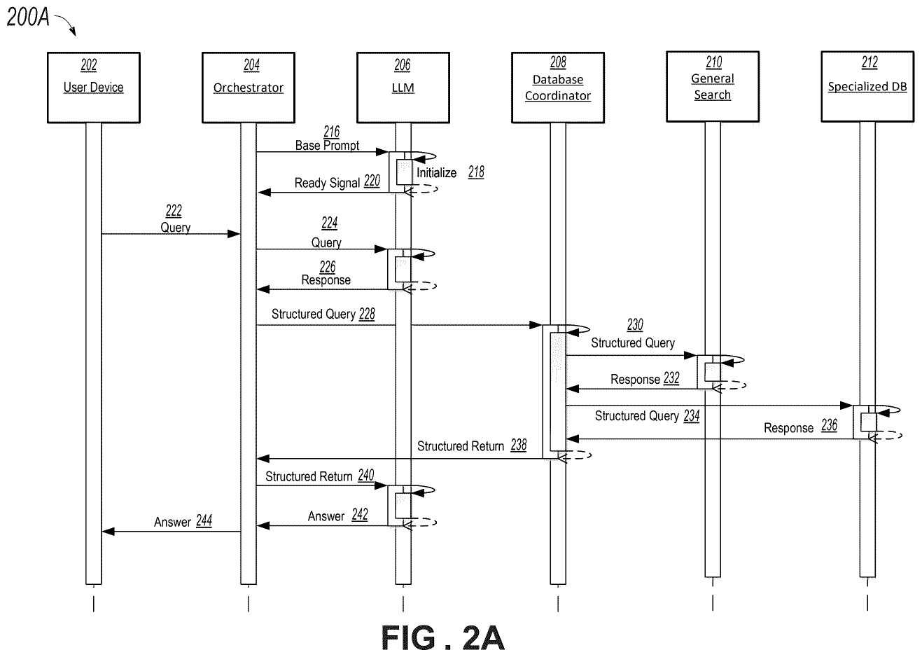

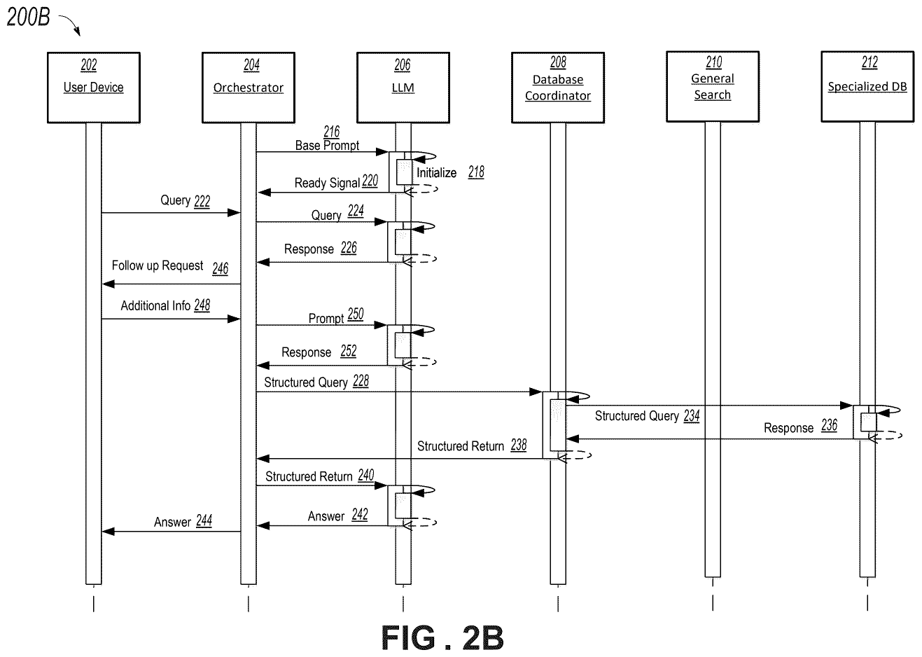

FIG. 2A is a swim lane diagram of an example process 200A for using an AI model to integrate with structured data repositories. It will be understood that process 200A and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 200A.

Process 200A shows an example timeline for how an orchestrator 204 can respond to a query from a user device 202, using an LLM 206, and a database coordinator 208. Initially, a base prompt 216 can be sent to the LLM 206. The base prompt can specify how the LLM 206 is to behave and can constrain the LLM 206 into a chain-of-thought-like output containing actionable steps. In general, the base prompt specifies that the LLM 206 is to respond with either a thought, action, or observation (answer). The LLM 206 can include a token in each response indicating the type of output the response is. The available actions can be defined in the base prompt and can include function calls, requests to different components, API requests, or other actions. In some implementations, this includes the orchestrator 204 providing credentials and authenticating with the LLM 206.

Upon receipt of the base prompt, the LLM 206 can initialize (218) and return a signal that it is ready to receive queries (220).

When the user sends a query 222 to the orchestrator 204, the orchestrator initially passes it (224) to the initialized LLM 206, which processes it and responds at 226. In the illustrated example, the LLM 206 responded by taking an action or requesting an action to be taken by the orchestrator 204, and the orchestrator passes a structured query 228 to the database coordinator 208. The database coordinator 208 can determine where the structured query is to be sent and distribute the query to the appropriate search services or databases. In some implementations, the database coordinator 208 selects the appropriate destination based on a tag or argument within the structured query. In some implementations, the database coordinator 208 performs a general search 210 first each time and based on the results of the general search, selects specialized databases 212 to query.

The structured query can be generated by the LLM 206 as a function call and can include arguments or data that is needed based on action defined in the base prompt. In some implementations, the orchestrator further modifies the structured query, by adding additional arguments, or filters based on the user device or user, and policies or requirements of an enterprise software system or computing environment. For example, an organization may have a policy that employees travel economy class unless they've traveled two times previously in the current quarter. The orchestrator can identify the employee based on the user device and determine that the employee has not traveled yet this quarter, and therefore structure the query to filter non-economy class flights.

In example 200A, at 230, the structured query is initially sent to a general search service 210, which can provide certain information and an initial response 232. In some implementations, the general search service 210 provides access to large quantities of relatively static information. The specialized database 212 can provide access to smaller quantities of specific information that can dynamically change, for example hourly, or even on a minute-to-minute basis. For example, the specialized database 212 can provide travel information such as hotel availability or flight information. Or the specialized database 212 can provide other information such as traffic, weather, stock pricing, or other time sensitive data.

The database coordinator 208 can receive a response 232 from the general search service 210 and send the structured query 234 to the specialized database 212. In some implementations, the response is stored in a memory with a unique identifier (e.g., a UUID). This unique identifier can be used in follow on queries to reference the initial response 232. In some implementations, the structured query can be refined, modified, or have additional information (such as the UUID) appended to it based on the response at 232. For example, the general search can yield a list of available flights that match the initial search criteria, and then those flights can be appended to the structured query when the specialized database is queried in order to provide specific pricing information for those particular flights. In some implementations, where the general search response does not fully satisfy the initial structured query, the additional search of the specialized database is conducted. In some implementations, the general search is sufficient and 234 and 236 do not occur.

The database coordinator can receive a response 236 which it can then format into a structured return 238 and send to the orchestrator 204. The structured return can be a response to the initial structured query 228 and can include the queried information in a structured format. The orchestrator can pass that structured return 240 to the LLM 206 which can use the information in the return to complete an answer 242 that it sends to the orchestrator 204. The orchestrator 204 can pass the answer to the user device 244 resulting in a final output.

In some implementations, additional responses and outputs that are not shown are returned from the LLM 206 to the orchestrator 204. These can be “thought traces,” observation, or other outputs that the orchestrator can record and use in training the LLM or reviewing overall system performance.

It should be noted that process 200A is merely an example, and events or portions of process 200A can occur in different sequences, simultaneously, or not at all.

FIG. 2B is a swim lane diagram of an example process 200B for using an AI model to integrate with structured data repositories. It will be understood that process 200B and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 200B.

Process 200B is similar to process 200A, except that response 226 is a request for additional information from the LLM instead of a function call or structured query. The orchestrator can pass the follow up request 246 to the user device 202 and receive a response 248 that includes the additional information. The additional information can be provided to the LLM in an additional prompt 250, and the LLM can provide an additional response 252 to the orchestrator. In example 200B, the additional response is a function call, and the orchestrator passes a structured query to the database generator as shown and described above with respect to FIG. 2A.

Another difference in example 200B is that the database coordinator 208 only queries the specialized database 212 bypassing the general search service 210 altogether. In some implementations the structured query can be sent to a single database, multiple databases in parallel, or multiple databases sequentially, with each return modifying the query. This solution can be advantageous in that it can relies exclusively on internal resources or databases. That is, no general or public search engine is required.

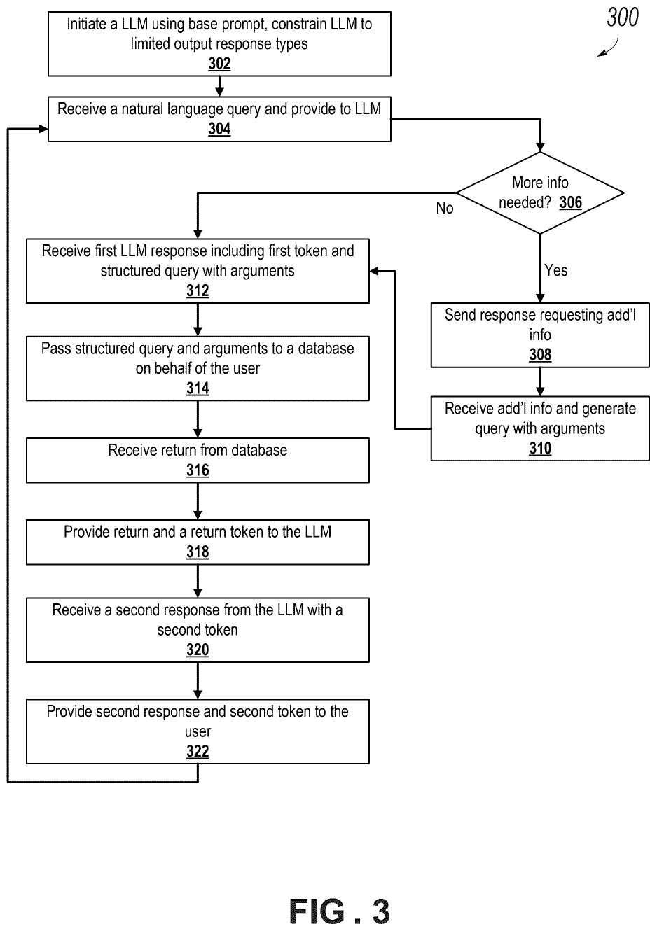

FIG. 3 is a flowchart of an example process 300 for using an AI model to integrate with structured data repositories. It will be understood that process 300 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 300. In some implementations, the process 300 and related methods are executed by one or more components of the system 100 described above with respect to FIG. 1, such as the orchestrator 102 and the AI system 104, and/or portions thereof.

At 302, the LLM is initiated using a base prompt which constrains the LLM to limited output response types. The output response types can be, for example, “thoughts”, “actions,” and “answers.” “Thoughts” can represent the LLM reading an input prompt and determining which actions to take based on the available and needed information. “Actions” represent a fixed set of permissible actions, which can be defined in the base prompt, and can include function calls, available arguments to the function calls, request for additional information, waiting, communicating with other AI models, or other actions. “Answers” can represent the LLM response to a second prompt, or any response that includes results from a previously taken action. Generally, “answers” can be considered outputs that are to be sent to the user.

The base prompt can require the LLM to respond with a token each time, indicating which type such responses might be, for example, “[observation]: I do not have enough information” or “[answer]: The distance from Paris to Nice is 932 kilometers.”

At 304, a natural language query is received from a user device and sent to the LLM for response. In some implementations, the natural language query is received in a chat box style user interface.

At 306, the LLM determines whether it can form a structured query to get an answer, or whether more information is required before it can form a complete structured query. If more information is required, then the process continues at 308. If sufficient information is present in the initial query, the LLM can immediately generate a structured query and process 300 can pass to 312.

At 308, a response is sent to the user requesting the additional information. For example, if the user requested a flight booking without specifying a departure date, the response may be a request for a departure date or a range of departure dates.

At 310, when the additional information is received, the LLM can generate a structured query, which can include a function call with completed arguments for the function. In some implementations, the function call includes some arguments that are placeholders to be completed at a later point in the process.

At 312, the structured query with arguments can be received. This LLM response can include a first token that indicates its response type is an action. For example, the first token can be [action], and indicate that the recipient is to pass the structured query to a database for information. In some implementations, the LLM response is received at an orchestrator such as orchestrator 102 of FIG. 1, and the orchestrator analyzes the response to determine if each argument is complete and that the structured query is syntactically correct. In some implementations, the structured response is parsed to generated structured arguments for use in downstream queries. For example, the LLM response can include arguments in plain language (e.g., “April the 23rd”), and the orchestrator can parse that date using a language parsing library into a structured argument (e.g., {“value”:“2124-4-23T00:00:00.000-07:00”,“grain”:“day”}. In some implementations, the language parsing library is Duckling, or similar program.

At 314, the structured query with arguments is passed to a database for processing. In some implementations, the structured query is appended or modified to include credentials, or user information associated with the user making the query, which can modify or filter the results based on the particular user or user's role.

At 316, a return from the structured query is received from the database. The return can be a structured return that includes the requested data in a specific format.

At 318, the orchestrator can provide the return to the LLM using a separate token indicating that it is a return associated with the original structured query. In some implementations the token is an encrypted or hashed version of the query that includes a digital signature. In some implementations, the token is a plaintext symbol of phrase such as “[response].”

At 320, a second response is received from the LLM reacting to the structured response from the database. The second response can include a second token, such as an [answer] token indicating that this response is to be sent back to the user.

At 322, the second response and second token are provided to the user. Upon receipt of the response, the user may submit an additional natural language query, continuing what is a conversational interaction. If an additional natural language query is submitted, process 300 can return to 304 and repeat.

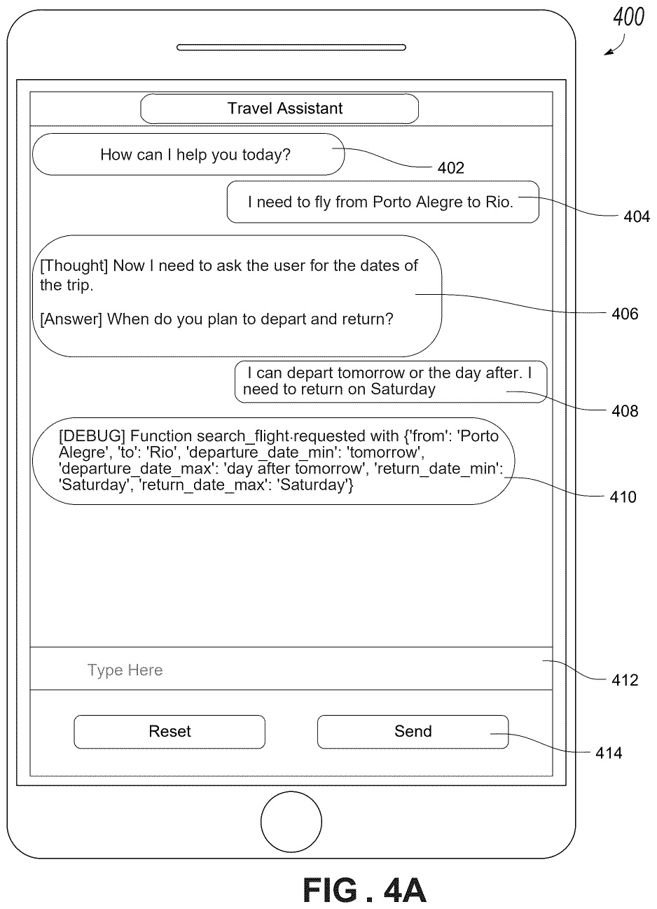

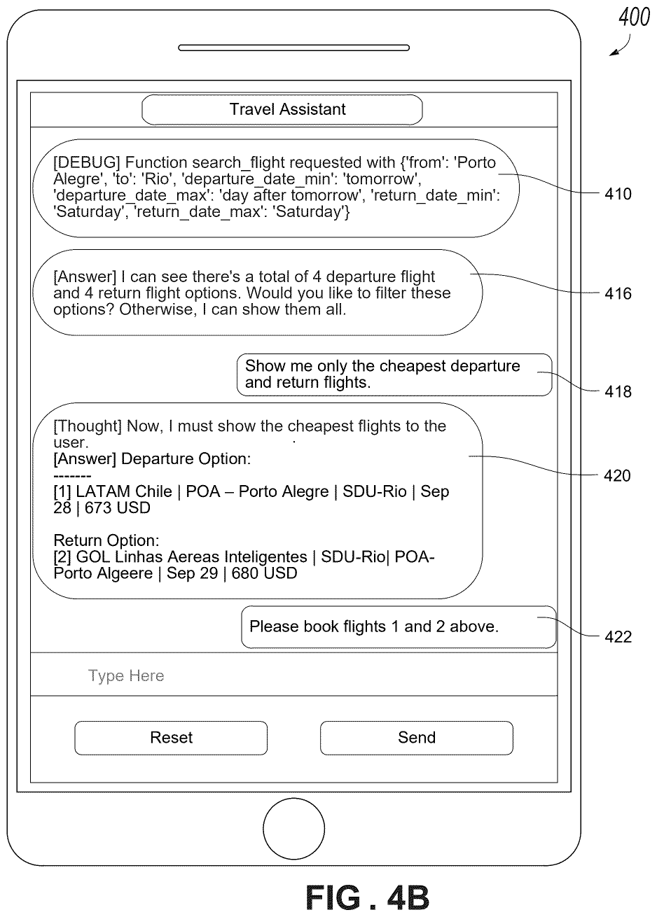

FIGS. 4A-4B are an example UI of an implementation using an AI model for travel booking. Further FIGS. 4A and 4B represent an example interaction between a user and the AI model using an orchestrator. A graphical user interface (GUI) 400 is displayed on an example client device, where the client interacts with the “travel assistant” using a text messaging format. GUI 400 can include buttons 414 and an input field 412 that perform various functions and generally enable the user to insert queries and text.

The travel assistant begins with an introduction 402 in response which the user queries the assistant by indicating the need to book a flight 404. In the illustrated example, the travel assistant responds twice, the first response is a thought response as indicated by the token [thought]. It should be noted that in FIGS. 4A and 4B the travel assistant is in a verbose mode, where every response from the LLM is passed to the user. This may be helpful for troubleshooting or development. In practice, limited responses may be passed to the user, such as [answer] only responses, while the other responses tokens such as [thought], [debug], etc., are recorded by an intermediate orchestrator, and not presented in GUI 400.

After establishing that more information is required, the travel assistant submits an [answer] 406 requesting additional information. The user response provides the requested information at 408, and the travel assistant can call a function at 410 with a set of arguments. Turning to FIG. 4B, the orchestrator will run the function against the appropriate data source and return the requested information to the travel assistant which can then respond with an answer which in this case, is a request for information on how to present the results 416.

At 418, in response to the travel assistant's answer, the user specifies how the results are to be displayed, causing the travel assistant to develop another [thought] response and then present the [answer] 420 according to the user's request.

Finally, at 422, the user sends an additional query, requesting the travel assistant to book the suggested flights.

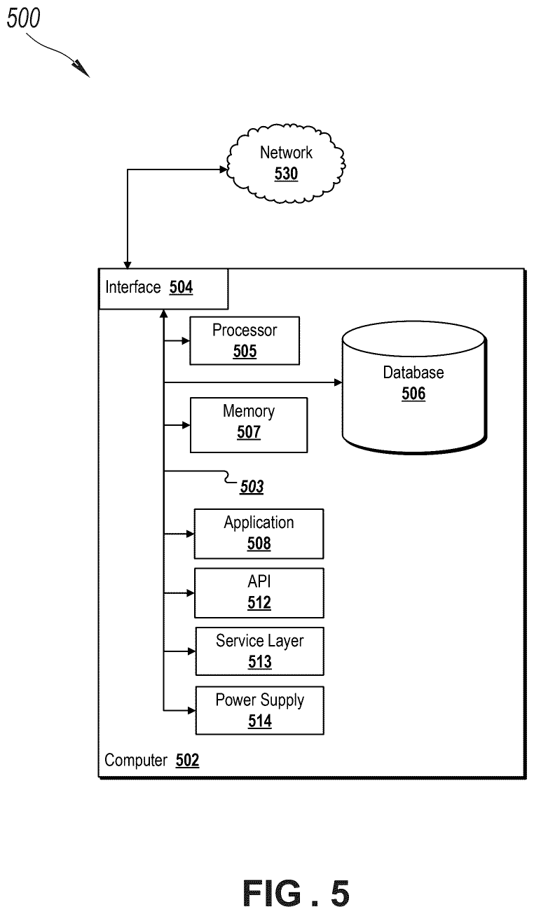

FIG. 5 is a block diagram illustrating an example of a computer-implemented system. 500 used to provide computational functionalities associated with described algorithms, methods, functions, processes, flows, and procedures, according to an implementation of the present disclosure. In the illustrated implementation, system 500 includes a computer 502 and a network 530.

The illustrated computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the computer 502 can include an input device, such as a keypad, keyboard, or touch screen, or a combination of input devices that can accept user information, and an output device that conveys information associated with the operation of the computer 502, including digital data, visual, audio, another type of information, or a combination of types of information, on a graphical-type user interface (UI) (or GUI) or other UI.

The computer 502 can serve in a role in a distributed computing system as, for example, a client, network component, a server, or a database or another persistency, or a combination of roles for performing the subject matter described in the present disclosure. The illustrated computer 502 is communicably coupled with a network 530. In some implementations, one or more components of the computer 502 can be configured to operate within an environment, or a combination of environments, including cloud-computing, local, or global.

At a high level, the computer 502 is an electronic computing device operable to receive, transmit, process, store, or manage data and information associated with the described subject matter. According to some implementations, the computer 502 can also include or be communicably coupled with a server, such as an application server, e-mail server, web server, caching server, or streaming data server, or a combination of servers.

The computer 502 can receive requests over network 530 (for example, from a client software application executing on another computer 502) and respond to the received requests by processing the received requests using a software application or a combination of software applications. In addition, requests can also be sent to the computer 502 from internal users (for example, from a command console or by another internal access method), external or third-parties, or other entities, individuals, systems, or computers.

Each of the components of the computer 502 can communicate using a system bus 503. In some implementations, any or all of the components of the computer 502, including hardware, software, or a combination of hardware and software, can interface over the system bus 503 using an application programming interface (API) 512, a service layer 513, or a combination of the API 512 and service layer 513. The API 512 can include specifications for routines, data structures, and object classes. The API 512 can be either computer-language independent or dependent and refer to a complete interface, a single function, or even a set of APIs. The service layer 513 provides software services to the computer 502 or other components (whether illustrated or not) that are communicably coupled to the computer 502. The functionality of the computer 502 can be accessible for all service consumers using the service layer 513. Software services, such as those provided by the service layer 513, provide reusable, defined functionalities through a defined interface. For example, the interface can be software written in a computing language (for example, JAVA or C++) or a combination of computing languages and providing data in a particular format (for example, extensible markup language (XML)) or a combination of formats. While illustrated as an integrated component of the computer 502, alternative implementations can illustrate the API 512 or the service layer 513 as stand-alone components in relation to other components of the computer 502 or other components (whether illustrated or not) that are communicably coupled to the computer 502. Moreover, any or all parts of the API 512 or the service layer 513 can be implemented as a child or a sub-module of another software module, enterprise application, or hardware module without departing from the scope of the present disclosure.

The computer 502 includes an interface 504. Although illustrated as a single interface 504, two or more interfaces 504 can be used according to particular needs, desires, or particular implementations of the computer 502. The interface 504 is used by the computer 502 for communicating with another computing system (whether illustrated or not) that is communicatively linked to the network 530 in a distributed environment. Generally, the interface 504 is operable to communicate with the network 530 and includes logic encoded in software, hardware, or a combination of software and hardware. More specifically, the interface 504 can include software supporting one or more communication protocols associated with communications such that the network 530 or hardware of interface 504 is operable to communicate physical signals within and outside of the illustrated computer 502.

The computer 502 includes a processor 505. Although illustrated as a single processor 505, two or more processors 505 can be used according to particular needs, desires, or particular implementations of the computer 502. Generally, the processor 505 executes instructions and manipulates data to perform the operations of the computer 502 and any algorithms, methods, functions, processes, flows, and procedures as described in the present disclosure.

The computer 502 also includes a database 506 that can hold data for the computer 502, another component communicatively linked to the network 530 (whether illustrated or not), or a combination of the computer 502 and another component. For example, database 506 can be an in-memory or conventional database storing data consistent with the present disclosure. In some implementations, database 506 can be a combination of two or more different database types (for example, a hybrid in-memory and conventional database) according to particular needs, desires, or particular implementations of the computer 502 and the described functionality. Although illustrated as a single database 506, two or more databases of similar or differing types can be used according to particular needs, desires, or particular implementations of the computer 502 and the described functionality. While database 506 is illustrated as an integral component of the computer 502, in alternative implementations, database 506 can be external to the computer 502. The database 506 can hold any data type necessary for the described solution.

The computer 502 also includes a memory 507 that can hold data for the computer 502, another component or components communicatively linked to the network 530 (whether illustrated or not), or a combination of the computer 502 and another component. Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507, two or more memories 507 or similar or differing types can be used according to particular needs, desires, or particular implementations of the computer 502 and the described functionality. While memory 507 is illustrated as an integral component of the computer 502, in alternative implementations, memory 507 can be external to the computer 502.

The application 508 is an algorithmic software engine providing functionality according to particular needs, desires, or particular implementations of the computer 502, particularly with respect to functionality described in the present disclosure. For example, application 508 can serve as one or more components, modules, or applications. Further, although illustrated as a single application 508, the application 508 can be implemented as multiple applications 508 on the computer 502. In addition, although illustrated as integral to the computer 502, in alternative implementations, the application 508 can be external to the computer 502.

The computer 502 can also include a power supply 514. The power supply 514 can include a rechargeable or non-rechargeable battery that can be configured to be either user-or non-user-replaceable. In some implementations, the power supply 514 can include power-conversion or management circuits (including recharging, standby, or another power management functionality). In some implementations, the power supply 514 can include a power plug to allow the computer 502 to be plugged into a wall socket or another power source to, for example, power the computer 502 or recharge a rechargeable battery.

There can be any number of computers 502 associated with, or external to, a computer system containing computer 502, each computer 502 communicating over network 530. Further, the term “client,” “user,” or other appropriate terminology can be used interchangeably, as appropriate, without departing from the scope of the present disclosure. Moreover, the present disclosure contemplates that many users can use one computer 502, or that one user can use multiple computers 502.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A computer implemented method comprising:
initiating a large language model (LLM) with a base prompt, the base prompt providing the LLM with a set of possible output actions, and constraining the LLM to respond with a thought response, output action, or an answer response;
receiving, from a user, a natural language query;
providing the natural language query to the LLM;
receiving a first response from the LLM comprising a first token and a structured query, wherein the first token indicates that the first response is an output action, and wherein the structured query comprises one or more arguments;
passing the structured query including the arguments to a database on behalf of the user;
receiving a return from the database;
generating a return token and providing the return token and the return from the database to the LLM, the return token indicating that the return from the database is in response to the structured query;
receiving a second response from the LLM, the second response comprising a second token indicating that the second response is an answer response; and
providing the second response to the user.

2. The method of claim 1, wherein the structured query is a travel search query requesting a travel booking, and wherein the arguments comprise travel dates and locations, and wherein the arguments are determined by the LLM based on the natural language query.

3. The method of claim 2, wherein determining the arguments by the LLM based on the natural language query comprises:
receiving an answer response from the LLM requesting additional information from the user;
sending the answer response requesting additional information to the user;
receiving a user response comprising the additional information; and
sending the user response to the LLM.

4. The method of claim 1, wherein receiving the natural language query from the user comprises receiving a set of credentials from the user, wherein passing the structured query to the database on behalf of the user comprises passing the set of credentials to the database.

5. The method of claim 1, wherein passing the structured query to the database on behalf of the user comprises passing user policy information to the database, and wherein the return from the database is based on the user policy information.

6. The method of claim 1, wherein the structured query is a query for flight information, and wherein passing the structured query to the database comprises passing the structured query to a database coordinator to search a plurality of database sources and retrieve flight information.

7. The method of claim 1, wherein passing the structured query to the database comprises:
extracting structured arguments from the arguments using a language parsing library.

8. The method of claim 1, wherein the database is a first database, and wherein passing the structured query including the arguments to the database comprises:
passing the structured query to the first database and receiving a first result;
refining the structured query with the first result;
passing the refined structured query to a second database and receiving a second result; and
providing the second result as the return from the database.

9. The method of claim 8, wherein refining the structured query with the first result comprises inserting UUIDs from the first result into the structured query.

10. A non-transitory, computer-readable medium storing one or more instructions executable by a computer system to perform operations comprising:
initiating a large language model (LLM) with a base prompt, the base prompt providing the LLM with a set of possible output actions, and constraining the LLM to respond with a thought response, output action, or an answer response;
receiving, from a user, a natural language query;
providing the natural language query to the LLM;
receiving a first response from the LLM comprising a first token and a structured query, wherein the first token indicates that the first response is an output action, and wherein the structured query comprises one or more arguments;
passing the structured query including the arguments to a database on behalf of the user;
receiving a return from the database;
generating a return token and providing the return token and the return from the database to the LLM, the return token indicating that the return from the database is in response to the structured query;
receiving a second response from the LLM, the second response comprising a second token indicating that the second response is an answer response; and
providing the second response to the user.

11. The medium of claim 10, wherein the structured query is a travel search query requesting a travel booking, and wherein the arguments comprise travel dates and locations, and wherein the arguments are determined by the LLM based on the natural language query.

12. The medium of claim 11, wherein determining the arguments by the LLM based on the natural language query comprises:
receiving an answer response from the LLM requesting additional information from the user;
sending the answer response requesting additional information to the user;
receiving a user response comprising the additional information; and
sending the user response to the LLM.

13. The medium of claim 10, wherein receiving the natural language query from the user comprises receiving a set of credentials from the user, wherein passing the structured query to the database on behalf of the user comprises passing the set of credentials to the database.

14. The medium of claim 10, wherein passing the structured query to the database on behalf of the user comprises passing user policy information to the database, and wherein the return from the database is based on the user policy information.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
initiating a large language model (LLM) with a base prompt, the base prompt providing the LLM with a set of possible output actions, and constraining the LLM to respond with a thought response, output action, or an answer response;
receiving, from a user, a natural language query;
providing the natural language query to the LLM;
receiving a first response from the LLM comprising a first token and a structured query, wherein the first token indicates that the first response is an output action, and wherein the structured query comprises one or more arguments;
passing the structured query including the arguments to a database on behalf of the user;
receiving a return from the database;
generating a return token and providing the return token and the return from the database to the LLM, the return token indicating that the return from the database is in response to the structured query;
receiving a second response from the LLM, the second response comprising a second token indicating that the second response is an answer response; and
providing the second response to the user.

16. The system of claim 15, wherein the structured query is a travel search query requesting a travel booking, and wherein the arguments comprise travel dates and locations, and wherein the arguments are determined by the LLM based on the natural language query.

17. The system of claim 16, wherein determining the arguments by the LLM based on the natural language query comprises:
receiving an answer response from the LLM requesting additional information from the user;
sending the answer response requesting additional information to the user;
receiving a user response comprising the additional information; and
sending the user response to the LLM.

18. The system of claim 15, wherein receiving the natural language query from the user comprises receiving a set of credentials from the user, wherein passing the structured query to the database on behalf of the user comprises passing the set of credentials to the database.

19. The system of claim 15, wherein passing the structured query to the database on behalf of the user comprises passing user policy information to the database, and wherein the return from the database is based on the user policy information.

20. The system of claim 15, wherein the structured query is a query for flight information, and wherein passing the structured query to the database comprises passing the structured query to a database coordinator to search a plurality of database sources and retrieve flight information.
